(19) United States
(12) Patent Application Publication
(10) Pub. No.: US 2026/0142765 A1
(43) Pub. Date: May 21, 2026

(54) METHOD AND APPARATUS OF SUPPORTING PHYSICAL UPLINK CONTROL CHANNEL (PUCCH) REPETITION

(71) Applicant: LENOVO (BEIJING) LIMITED, Beijing (CN)

(72) Inventors: Hongmei Liu, Beijing (CN); Yuantao Zhang, Beijing (CN); Zhi Yan, Beijing (CN); Ruixiang Ma, Beijing (CN); Haiming Wang, Beijing (CN)

(21) Appl. No.: 19/113,492

(22) PCT Filed: Nov. 2, 2022
(86) PCT No.: PCT/CN2022/129229

§ 371 Date: Mar. 20, 2025

(51) Int. Cl. H04L 5/00; H04W 72/044; H04W 74/0833

(52) U.S. Cl. CPC H04L 5/0044; H04W 72/044; H04W 74/0833

(57) ABSTRACT

Embodiments of the present application are related to a method and apparatus of supporting physical uplink control channel (PUCCH) repetition. According an embodiment of the present application, an exemplary method includes: receiving a first signaling indicating a first repetition number for a PUCCH resource; determining a second repetition number equal to or smaller than the first repetition number based on the first repetition number; determining time-frequency domain resources for each repetition of the PUCCH resource; and transmitting the PUCCH resource with the second repetition number based on the determined time-frequency domain resources.

### TECHNICAL FIELD

Embodiments of the present application generally relate to wireless communication technology, and more particularly related to a mechanism of supporting physical uplink control channel (PUCCH), e.g., supporting PUCCH repetition (or PUCCH with repetition, or repetition for PUCCH).

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

Although a mechanism of PUCCH repetition has already been applied for improving the robustness of PUCCH transmissions, there are still several issues on PUCCH repetition to be solved in NR. For example, it has been agreed in RAN1_110bise meeting that PUCCH repetition will be supported for common PUCCH resource before radio resource control (RRC) configuration, e.g., Msg4 hybrid automatic repeat request (HARQ)-acknowledge (ACK), and how to support will be studied. In another example, PUCCH repetition in non-terrestrial network (NTN) also needs to be considered.

Thus, it is desirable to provide a technical solution to improve the mechanism of PUCCH repetition to adapt the industry trend.

### SUMMARY OF THE DISCLOSURE

One objective of embodiments of the present application is to provide a technical solution of supporting PUCCH repetition, especially a method and apparatus of supporting PUCCH repetition, which can support PUCCH repetition for common PUCCH resource before RRC configuration and/or improve PUCCH repetition in scenarios of NTN.

Some embodiments of the present application provide an apparatus, e.g., a UE, which includes: a transceiver; and a processor coupled to the transceiver, wherein the processor is configured to: receive a first signaling indicating a first repetition number for a PUCCH resource; determine a second repetition number equal to or smaller than the first repetition number based on the first repetition number; determine time-frequency domain resources for each repetition of the PUCCH resource; and transmit the PUCCH resource with the second repetition number based on the determined time-frequency domain resources.

Some other embodiments of the present application provide a method, e.g., a method performed in a UE, which includes: receiving a first signaling indicating a first repetition number for a PUCCH resource; determining a second repetition number equal to or smaller than the first repetition number based on the first repetition number; determining time-frequency domain resources for each repetition of the PUCCH resource; and transmitting the PUCCH resource with the second repetition number based on the determined time-frequency domain resources.

In some embodiments of the present application, the first signaling indicating the first repetition number is system information or downlink control information.

In some embodiments of the present application, the first repetition number is indicated by HARQ timing indicator.

In some embodiments of the present application, a start position of the time-frequency domain resources for the PUCCH resource with the second repetition number being N, N>=1, is one of: positions corresponding to every N time-frequency domain resources.

In some embodiments of the present application, a start position of the time-frequency domain resources for the PUCCH resource with the second repetition number is indicated by a second signaling, or is selected by remote side.

In some embodiments of the present application, the first repetition number is determined based on a received row index associated with a repetition number for PUCCH in a configured or predefined table.

In some embodiments of the present application, the first repetition number is determined based on a repetition number for Msg A, Msg 3 or physical random access channel (PRACH).

In some embodiments of the present application, the processor is configured to: transmit information indicating repetition is requested for PUCCH or information indicating a repetition number for PUCCH before determining the first repetition number. According to some embodiments of the present application, the information indicating repetition is requested for PUCCH is one of the following: PRACH repetition; a repetition request for Msg A or Msg 3; at least one bit in Msg A or in Msg 3; or a specific PRACH resource.

In some embodiments of the present application, the second repetition number is determined based on at least one of the following: reference signal received power (RSRP); satellite position; satellite elevation angle; timing advanced value; or distance between satellite and remote side. According to some embodiments of the present application, the processor is configured to: receive information indicating at least one threshold associated with the second repetition number: RSRP threshold; satellite position threshold; satellite elevation angle threshold; timing advanced value threshold; or distance threshold between satellite and remote side.

In some embodiments of the present application, the time-frequency domain resources for each repetition of the PUCCH resource are slot level or symbol level.

According to some embodiments of the present application, in the case that the time-frequency domain resources for each repetition are symbol level, a symbol level gap between adjacent repetitions will be configured or predefined.

According to some embodiments of the present application, for each repetition of the PUCCH resource, in the case that the time-frequency domain resources for each repetition are symbol level and remaining available symbols excluding the symbol level gap in a slot is less than a number of symbols for a repetition of PUCCH resource, the repetition will start from a next slot.

According to some embodiments of the present application, whether the time-frequency domain resources for each repetition of the PUCCH resource are slot level or symbol level is configured or is determined by one of the following: a number of symbols for each repetition; HARQ timing indicator; or HARQ resource indicator. In some scenarios, in the case that whether the time-frequency domain resources for each repetition of the PUCCH resource are slot level or symbol level is determined by the HARQ resource indicator, a number of HARQ resources associated with the HARQ resource indicator will be reduced from a number of HARQ resources associated with a HARQ resource indicator without indication for slot level or symbol level. For example, the number of HARQ resources will be reduced by at least one of: reduction of number of resource block (RB) position; reduction of number of orthogonal cover code (OCC) sequences; reduction of number of cyclic shift (CS) values.

According to some embodiments of the present application, corresponding interpretation of the HARQ timing indicator is based on whether there is a repetition request transmitted from remote side.

According to some embodiments of the present application, corresponding interpretation of the HARQ resource indicator is based on whether there is a repetition request transmitted from remote side.

According to some embodiments of the present application, corresponding interpretation of the table is based on whether there is a repetition request transmitted from remote side.

Some yet other embodiments of the present application provide another apparatus, e.g., a gNB, which includes: a transceiver; and a processor coupled to the transceiver, wherein the processor is configured to: transmit a first signaling indicating a first repetition number for a PUCCH resource; determine a second repetition number equal to or smaller than the first repetition number based on the first signaling; determine time-frequency domain resources for each repetition of the PUCCH resource; and receive the PUCCH resource with the second repetition number based on the determined time-frequency domain resources.

Given the above, embodiments of the present application provide a technical solution of supporting PUCCH repetition, e.g., supporting repetition for common PUCCH resource before RRC configuration, which improves the mechanism of PUCCH repetition and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary procedure of a method of supporting PUCCH repetition according to some embodiments of the present application.

FIG. 3 illustrates a schematic diagram illustrating exemplary PUCCH resources with symbol level repetitions according to some embodiments of the present application.

FIG. 4 is a schematic diagram illustrating possible start positions of time-frequency domain resources for PUCCH repetition under Rule 1 according to some embodiments of the present application.

FIG. 5 illustrates a block diagram of an exemplary apparatus of supporting PUCCH repetition according to some embodiments of the present application.

FIG. 6 illustrates a block diagram of an exemplary apparatus of supporting PUCCH repetition according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

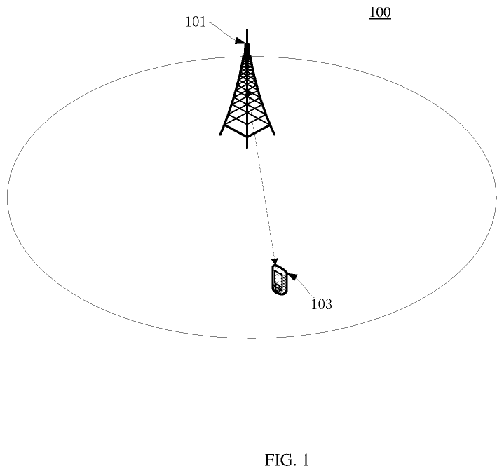

FIG. 1 illustrates a schematic diagram of an exemplary wireless communication system 100 according to some embodiments of the present application.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some scenarios, to extend the coverage and availability of wireless communication systems (e.g., 5G systems), satellites and high-altitude platforms may be utilized as relay devices in communications related to ground devices such as UE. Network or segment of network using radio frequency (RF) resources on board a satellite or an airborne aircraft may be referred to as an NTN. In the NTN, some or all functions of a BS may be deployed in a satellite or an airborne aircraft. That is, in the NTN, a satellite may be also referred to as a BS. Exemplary satellites include low earth orbiting (LEO) satellites, medium earth orbiting (MEO) satellites, geostationary earth orbiting (GEO) satellites, as well as highly elliptical orbiting (HEO) satellites etc. In some embodiments of the present application, alternatively, a satellite may be an unmanned aircraft systems (UAS) platform. The UAS platform(s) may include tethered UAS and lighter than air (LTA) UAS, heavier than air (HTA) UAS, and high altitude platform (HAP) UAS.

Since 3GPP Release 15, a mechanism of PUCCH repetition with inter-slot frequency hopping has already been supported for improving the robustness of PUCCH transmissions, and has been drafted in 3GPP standard document TS38.213. However, the legacy mechanism of PUCCH repetition is only for dedicated PUCCH resource, wherein, PUCCH repetition can be configured at slot level, and symbol occupation at each slot are same for the PUCCH repetition. For common PUCCH resource before RRC configuration or PUCCH for Msg 4, there is no PUCCH repetition. How to determine the repetition number for common PUCCH resource before RRC configuration, and how to indicate the repetition number for common PUCCH resource before RRC configuration etc. issues need to be solved. In addition, characteristics of NTN were not considered in legacy mechanism of PUCCH repetition. Whether PUCCH repetition in NTN will be improved also needs to be considered.

At least considering the above issues, embodiments of the present application propose a technical solution of supporting PUCCH repetition, e.g., a method and apparatus of supporting PUCCH repetition.

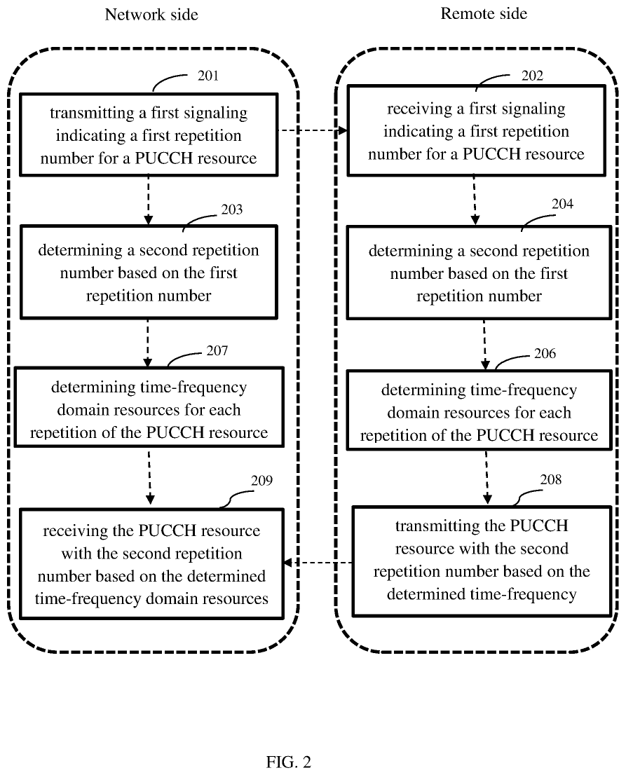

FIG. 2 is a flow chart illustrating an exemplary procedure of a method of supporting PUCCH repetition according to some embodiments of the present application. Although the method is illustrated in a system level including a BS (e.g., gNB) in network side and a remote device, e.g., UE in remote side, persons skilled in the art should understand that the method implemented in the network side and remote side can be separately implemented and/or incorporated by other apparatus with the like functions.

Referring to FIG. 2, a BS or the like, e.g., a gNB may transmit a first signaling indicating a first repetition number for a PUCCH resource (or a first repetition number for PUCCH), e.g., to a UE or the like in step 201. Accordingly, the UE will receive the first signaling indicating a first repetition number for a PUCCH resource in step 202. The gNB may indicate the first repetition number for PUCCH to the UE on its own initiative, e.g., in the case of cell specific manner configuration for PUCCH repetition. In some other scenarios, e.g., in the case of UE specific manner configuration for PUCCH repetition, the gNB may indicate the first repetition number for PUCCH to the UE in response to receiving related information, which indicates repetition is requested for PUCCH or indicates a repetition number for PUCCH.

The first repetition number may be 1, 2, 4, 8 or other non-zero integer, which means there will be 1, 2, 4, 8 or other non-zero integer transmission of a PUCCH resource from the remote side. The first signaling can be various signaling, e.g., system information, RRC, media access control (MAC) control element (CE) or downlink control information (DCI) etc. which can directly or indirectly indicate the first repetition number for PUCCH. For example, the gNB may directly indicate the first repetition number for PUCCH being 2 in system information or in HARQ timing indicator. In another example, the gNB may indirectly indicate the first repetition number for PUCCH by indicating a row index associated with a repetition number for PUCCH in a configured or predefined table or by indicating a repetition number for Msg A, Msg 3 or PRACH etc.; and the UE will determine the first repetition number for PUCCH based on the indicated row index, or the indicated repetition number for Msg A, Msg 3 or PRACH etc. An exemplary configured or predefined table is a table evolved from legacy Table 9.2.1-1 “PUCCH resource sets before dedicated PUCCH resource configuration” in TS 38.213 or the like, wherein one or more row indexes of the configured or predefined table are associated with corresponding repetition number(s) for PUCCH.

A second repetition number preferred or used by the UE will be determined (or selected) based on the first repetition number respectively by the gNB in step 203 and the UE in step 204. The first repetition number for PUCCH indicated by the gNB may not be preferred by the UE, especially in the case that the first repetition number is not requested by the UE in advance. Thus, the second repetition number may not identical with the first repetition number, which is equal to or smaller than the first repetition number. For example, the first repetition number for PUCCH is determined in cell specific manner by the gNB considering a UE with the worst channel condition in the cell. Then, for a specific UE receiving the first repetition number considering the worst channel condition, it can only perform PUCCH repetition with its preferred repetition number, which is equal to or smaller than the first repetition number.

The second repetition number can be determined in various manners. For example, the second repetition number can be determined based on RSRP as legacy. In another example, at least one characteristic of NTN, e.g., satellite position, satellite elevation angle, timing advanced value, or distance between satellite and remote side etc. may also be considered when determining the second repetition number. At least one threshold associated with the second repetition number may be configured in some scenarios. For example, the gNB may transmit information indicating at least one threshold associated with the second repetition number to the UE, which includes but is not limited to: RSRP threshold; satellite position threshold; satellite elevation angle threshold; timing advanced value threshold; or distance threshold between satellite and remote side (or UE). In some scenarios, e.g., in the case of UE specific manner configuration for PUCCH repetition, the UE may use the at least one threshold to determine whether PUCCH repetition is necessary or determine a preferred PUCCH repetition number.

Persons skilled in the art should well know that herein, wordings, such as “the first” and “the second” etc., are only used to distinguish similar features or elements etc., for clearness, and should not be deemed as limitation to the scope of the technical solutions.

In step 206, the UE will determine time-frequency domain resources for each repetition of the PUCCH resource; and then transmit the PUCCH resource with the second repetition number based on the determined time-frequency domain resources in step 208. Consistently, the gNB will determine time-frequency domain resources for each repetition of the PUCCH resource in step 207; and then receive the PUCCH resource with the second repetition number based on the determined time-frequency domain resources in step 209. As the first repetition number may be different from the second repetition number, blind detection at the gNB side is necessary for receiving the PUCCH resource with the second repetition number in some scenarios, e.g., the PUCCH repetition is configured in cell specific manner.

The time-frequency domain resources for each repetition of the PUCCH resource can be determined in various manners. For example, a start position of the time-frequency domain resources for the PUCCH resource with a repetition number being N, N>=1, is one of: positions corresponding to every N time-frequency domain resources. In another example, a start position of the time-frequency domain resources for the PUCCH resource with a repetition number is indicated by a second signaling from the gNB, or is selected by the remote side (e.g., UE).

Exemplary time-frequency domain resources for each repetition are a set of symbols including one or more symbols, which are slot level or symbol level (or each repetition for PUCCH is slot level or symbol level). In the case that the time-frequency domain resources for each repetition are slot level (that is, each repetition for PUCCH is slot level, also referred to as slot level repetition), the legacy slot level repetition mechanism can be applied similarly.

When the time-frequency domain resources for each repetition are symbol level (that is, each repetition for PUCCH is symbol level, also referred to as symbol level repetition), legacy Table 9.2.1-1 in TS 38.213 or the like will be adopted to determine the starting symbol in the first slot for the first repetition of a PUCCH with a number of repetitions. In some scenarios, the second repetition of the PUCCH with a number of repetitions will just follow the first repetition and so on, that is, there is no gap or zero-gap between adjacent repetitions for the PUCCH. In some other scenarios, in the case that each repetition for PUCCH is symbol level, a symbol level gap between adjacent repetitions will be configured or predefined, wherein no gap or zero-gap can be deemed as a special case of the symbol level gap. For symbol level repetition, in the case that remaining available symbols excluding the symbol level gap in a slot is less than a number of symbols for a repetition of PUCCH resource, the repetition will start from a next slot.

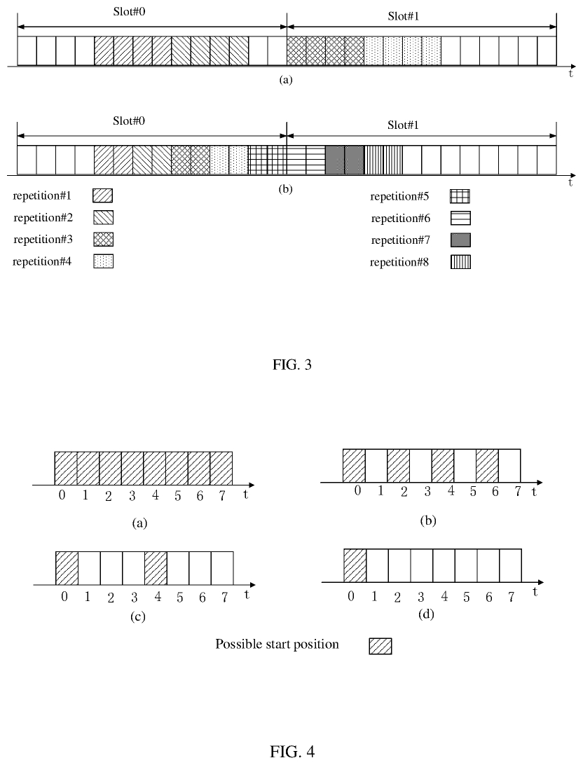

FIG. 3 illustrates a schematic diagram illustrating exemplary PUCCH resources with symbol level repetitions according to some embodiments of the present application.

Referring to FIG. 3, it is assumed that there is no gap (or zero-gap) between two adjacent repetitions of a PUCCH resource with symbol level repetitions either in scenarios (a) or in scenarios (b). Each slot, e.g., slot #0 or slot #1 in scenarios (a) and (b) includes 14 symbols.

Specifically, in scenarios (a), there is a PUCCH resource with 4 symbol level repetitions, and each symbol level repetition occupies 4 symbols. The first repetition of the PUCCH resource starts from the fifth symbol in slot #0. Then, after the second repetition, there are only 2 remaining symbols in slot #0, which are less than 4 symbols for a symbol level repetition. Accordingly, the third repetition will start from the first symbol in slot #1 rather than the thirteenth symbol in slot #0.

Similarly, in scenarios (b), there is a PUCCH resource with 8 symbol level repetitions, and each symbol level repetition occupies 2 symbols. The first repetition of the PUCCH resource starts from the fifth symbol in slot #0. Then, after the fifth repetition, there is no remaining symbol in slot #0. Accordingly, the sixth repetition will start from the first symbol in slot #1.

Compared with the mechanism of slot level repetition, the mechanism of symbol level repetition can reduce latency. In some scenarios, e.g., a first repetition number for PUCCH being indicated in a UE specific manner, the UE needs to differentiate whether slot level repetition is configured or symbol level repetition is configured, which can be achieved in various manners.

According to some embodiments of the present application, whether the time-frequency domain resources for each repetition of the PUCCH resource are slot level or symbol level is configured, e.g., by system information. According to some other embodiments of the present application, whether the time-frequency domain resources for each repetition of the PUCCH resource are slot level or symbol level is determined based on related information, e.g., based on a number of symbols for each repetition, or based on a HARQ timing indicator, or based on a HARQ resource indicator etc.

For example, whether slot level PUCCH repetition or symbol level PUCCH repetition is configured is determined based on the number of symbols for each repetition of the PUCCH. If the number of symbols is 2 or 4, it is symbol level repetition; otherwise, it is slot level repetition.

In another example, whether slot level PUCCH repetition or symbol level PUCCH repetition is configured is determined based on 1 bit (or more bits) in HARQ timing indicator, which may be an existing bit in legacy HARQ timing indicator reused to indicate symbol level repetition or slot level repetition. In the case that the HARQ timing indicator is used to indicate symbol level repetition or slot level repetition and also used to indicate the first repetition number for PUCCH, the HARQ timing indicator may fail to indicate a time delay between Msg 4 (or Msg B) and a corresponding common PUCCH after Msg 4 (or MsgB). In such a case, a default time delay will be adopted.

In yet another example, whether slot level PUCCH repetition or symbol level PUCCH repetition is configured is determined based on 1 bit (or more bits) in HARQ resource indicator, which may be an existing bit in legacy HARQ resource indicator reused to indicate symbol level repetition or slot level repetition. In this case, a number of HARQ resources associated with the HARQ resource indicator will be reduced from a number of HARQ resources associated with a HARQ resource indicator without indication for slot level or symbol level (e.g., a legacy HARQ resource indicator). For example, based on legacy Table 9.2.1-1 in TS38. 213, the available HARQ resources for PUCCH resource selection will be 8 rather than 16. The number of HARQ resources will be reduced by various manners, e.g., by at least one of: reduction of number of RB position; reduction of number of OCC sequences; or reduction of number of CS values.

In the case that legacy table, e.g., Table 9.2.1-1 in TS 38. 213 or indicator(s), e.g., HARQ timing indicator or HARQ resource indicator are improved or reused to indicate information related to repetition for PUCCH, e.g., indicating a PUUCH repetition number, indicating whether there is PUCCH repetition or indicating whether symbol level repetition or slot level repetition is configured etc., how to correctly interpret the received information associated with the table or indicator(s) is important because the legacy table or indicator(s) may also applicable in the case of no PUCCH repetition. According to some embodiments of the present application, corresponding interpretation is based on whether there is a repetition request transmitted from remote side. For example, corresponding interpretation associated with a received row index in a configured or predefined table of “PUCCH resource sets before dedicated PUCCH resource configuration” is based on whether there is a repetition request transmitted from remote side. Only when a UE reports its preferred repetition number is larger than 1 or when a UE reports that PUCCH repetition is necessary, the new table will be used; otherwise, the legacy table will be applied and there is no PUCCH repetition.

More detailed embodiments of the present application will be illustrated below respectively in view of PUCCH repetition configured in cell specific manner and UE specific manner. Although different exemplary embodiments are illustrated focusing on specific scenarios for clearness, they may also be applied in various scenarios by persons skilled in the art under the disclosure and teaching of the present application.

### PUCCH Repetition Configured in Cell Specific Manner

In some embodiments of the present application, PUCCH repetition is configured for a UE in a cell specific manner (also referred to as cell specific repetition number configuration for PUCCH). PUCCH resources and corresponding time domain offsets etc. for each UE can be determined as in legacy release or based on symbol level repetition. Only the repetition number for PUCCH will be determined according to related cell specific configuration and UE itself.

For example, the gNB may configure a first repetition number for PUCCH in system information, which may be determined considering a UE with the worst channel condition in the related cell.

After receiving the first repetition number for PUCCH, a specific UE will determine a preferred repetition number (the second repetition number) for PUCCH based on the first repetition number, which is equal to or smaller than the first repetition number. The specific UE may perform the PUCCH with its determined repetition number.

The gNB will also try to determine the second repetition number for the specific UE. However, blind detection at the gNB side is necessary. The reserved time domain resources for PUCCH repetition will be based on the first repetition number. The actual occupied time domain resources for PUCCH repetition will be determined based on configuration of the related PUCCH resource, the second repetition number and whether slot level repetition or symbol level repetition is configured etc. To ease blind detection at the gNB side, there are some restrictions or rules on the time domain resources for PUCCH repetition according to some embodiments of the present application, e.g., some restrictions or rules on the start position of the time-frequency domain resources for PUCCH repetition. The gNB will start the blind detection according to the determined start position of the time-frequency domain resources.

For example, the start position of the occupied time-frequency domain resources will be explicitly indicated by the gNB, e.g., by HARQ timing indicator in DCI in some embodiments of the present application. In some other embodiments of the present application, the start position of the occupied time-frequency domain resources will be selected by the UE, which may be randomly and will be blindly decoded by the gNB.

An exemplary rule (Rule 1) for start position of time domain resources for PUCCH repetition is: for a PUCCH resource with the second repetition number being N, N>=1, possible start positions of the time-frequency domain resources include: positions corresponding to every N time-frequency domain resources. That is, a possible start position of the occupied time-frequency domain resources is one of positions corresponding to every N time-frequency domain resources.

FIG. 4 is a schematic diagram illustrating possible start positions of time-frequency domain resources for PUCCH repetition under Rule 1 according to some embodiments of the present application.

Referring to FIG. 4, it is assumed that 8 time-frequency domain resources are occupied for PUCCH repetition. Exemplary repetition number 8 is configured in a cell-specific manner.

In scenarios (a), the repetition number is 1, and the possible starting positions will be in time-frequency domain resources 0, 1, 2, 3, 4, 5, 6 and 7, and the gNB will start the blind detection possibly in time-frequency domain resources 0, 1, 2, 3, 4, 5, 6 and 7. In scenarios (b), the second repetition number is 2, the possible starting positions will be in time-frequency domain resources 0, 2, 4 and 6, and the gNB will start the blind detection possibly in time-frequency domain resources 0, 2, 4, and 6. In scenarios (c), the second repetition number is 4, the possible starting positions will be in time-frequency domain resources 0 and 4, and the gNB will start the blind detection possibly in time-frequency domain resources 0 and 4. In scenarios (d), the second repetition number is 8, the possible starting position will only be in time-frequency domain resource 0, and the gNB will start the blind detection only in time-frequency domain resource 0.

### PUCCH Repetition Configured in UE Specific Manner

In some embodiments of the present application, PUCCH repetition is configured for a UE in a UE specific manner (also referred to as UE specific repetition number configuration for PUCCH). PUCCH repetition configured in a UE specific manner will avoid resource waste at the network side because the PUCCH resource reservation will not always consider the worst UE with largest repetition number.

In some scenarios, only the repetition number larger than 1 will be configured for PUCCH in a UE specific manner, e.g., in the case that the gNB receives information from the UE indicating a repetition number larger than 1 for PUCCH.

In some other scenarios, any repetition number can be configured for PUCCH in a UE specific manner, e.g., in the case that the gNB receives information from the UE indicating repetition is requested for PUCCH or with any repetition number including 1.

The gNB can indicate the repetition for PUCCH (the first repetition number) to a UE in UE specific manner.

For example, the PUCCH repetition number, e.g., a number larger than 1 is indicated by HARQ timing indicator in DCI. An exemplary HARQ timing indicator for indicating PUCCH repetition number is reusing a legacy HARQ timing indicator. There are 3 bits for legacy HARQ timing indicator to indicate the time domain offset between Msg4 (or MsgB) and following PUCCH. When HARQ timing indicator is used for indicating the PUCCH repetition number, 1 bit will be remained to indicate the time domain offset, and the other 2 bits will be used to indicate the PUCCH repetition number. As stated above, the HARQ timing indicator may indicate symbol level repetition or slot level repetition and also indicate the PUCCH repetition number, and there is no bit for indicating a time delay between Msg 4 and a corresponding PUCCH after Msg 4. In such a case, a default time delay will be adopted.

In another example, the gNB may indirectly indicate the PUCCH repetition number (first repetition number) by indicating a row index associated with a repetition number for PUCCH in a configured or predefined table. The PUCCH repetition number can be 1 or larger than 1. The UE will determine the first repetition number for PUCCH based on the indicated row index. An exemplary configured or predefined table is Table 1 as illustrated below, which evolves from legacy Table 9.2.1-1 in TS 38.213, wherein different row indexes in Table 1 are associated with different repetition numbers for PUCCH. PUCCH repetition number being 1 can be supported for one PUCCH configuration in a remaining row, e.g., row index being 1. Although only PUCCH with number of symbols being 14 is supported in Table 1, persons skilled in the art should well know that similar table(s) can be designed for supporting PUCCH with other number of symbols.

TABLE 1

| Index | PUCCH format | First symbol | Number of symbols | $PRB offset {RB}_{BWP}^{offset}$ | Set of initial CS indexes | Repetition number |
|---|---|---|---|---|---|---|
| 0 | 1 | 0 | 14 | $⌊ {N}_{BWP}^{s i z e} / 4 ⌋$ | {0, 3, 6, 9} | 1 |
| 1 | 1 | 0 | 14 | 0 | {0, 6} | 2 |
| 2 | 1 | 0 | 14 | 0 | {0, 3, 6, 9} | 2 |
| 3 | 1 | 0 | 14 | 2 | {0, 3, 6, 9} | 2 |
| 4 | 1 | 0 | 14 | 4 | {0, 3, 6, 9} | 2 |
| 5 | 1 | 0 | 14 | $⌊ {N}_{BWP}^{s i z e} / 4 ⌋$ | {0, 3, 6, 9} | 2 |
| 6 | 1 | 0 | 14 | 0 | {0, 6} | 4 |
| 7 | 1 | 0 | 14 | 0 | {0, 3, 6, 9} | 4 |
| 8 | 1 | 0 | 14 | 2 | {0, 3, 6, 9} | 4 |
| 9 | 1 | 0 | 14 | 4 | {0, 3, 6, 9} | 4 |
| 10 | 1 | 0 | 14 | $⌊ {N}_{BWP}^{s i z e} / 4 ⌋$ | {0, 3, 6, 9} | 4 |
| 11 | 1 | 0 | 14 | 0 | {0, 6} | 8 |
| 12 | 1 | 0 | 14 | 0 | {0, 3, 6, 9} | 8 |
| 13 | 1 | 0 | 14 | 2 | {0, 3, 6, 9} | 8 |
| 14 | 1 | 0 | 14 | 4 | {0, 3, 6, 9} | 8 |
| 15 | 1 | 0 | 14 | $⌊ {N}_{BWP}^{s i z e} / 4 ⌋$ | {0, 3, 6, 9} | 8 |

In yet another example, the gNB may indirectly indicate the PUCCH repetition number by indicating a repetition number for Msg A or Msg 3. The PUCCH repetition number can be 1 or larger than 1. A relationship between the PUCCH repetition number and the repetition number for Msg A or Msg 3 will be configured or predefined. For example, according to a configured or predefined relationship, repetition numbers for Msg A or Msg 3 may be 1, 2, 3, 4, each corresponding to a PUCCH repetition number being 1, 2, 4 or 8, respectively.

In yet another example, the gNB may indirectly indicate the PUCCH repetition number by indicating a repetition number for PRACH. The PUCCH repetition number can be 1 or larger than 1. Similarly, a relationship between the PUCCH repetition number and the repetition number for PRACH will be configured or predefined, so that the PUCCH repetition number can be determined based on the repetition number for PRACH.

Besides determining the second repetition for PUCCH after receiving the first repetition number, in some scenarios, UE may determine whether PUCCH repetition is necessary at UE side and indicate that to gNB before receiving the first repetition number from the network side.

In legacy network, a RSRP threshold may be configured from the network to UE. The UE can determine the repetition number based on the measured RSRP value and the RSRP threshold. In NTN network, since the satellite is moving according to an orbit, different position of the satellite can lead to different pathlosses and then lead to different PUCCH repetition number. Thus, besides the legacy mechanism based on RSRP, according to some embodiments of the present application, e.g., in NTN, the UE may also determine the PUCCH repetition number based on at least one of: satellite position, satellite elevation angle, timing advanced value calculated by the UE, or distance between satellite and remote side etc. characteristics of NTN. The information can be determined based on satellite ephemeris information. At least one NTN characteristic threshold, e.g., a satellite position threshold, or satellite elevation angle threshold, or timing advanced value threshold, or distance threshold between satellite and UE etc. may be configured from the gNB to the UE, e.g., in system information. Accordingly, the UE can determine the PUCCH repetition number (which may be the second repetition number or a preferred repetition number indicated to the gNB) based on the configured threshold and the corresponding characteristic of NTN based on satellite ephemeris information, e.g., satellite position, and/or satellite elevation angle, TA value, distance between satellite and UE, etc.

In some scenarios, the UE may only indicate to the gNB whether PUCCH repetition is preferred by the UE. In some other scenarios, the UE may indicate to the gNB a specific PUCCH repetition number.

For example, the UE may indicate that repetition is requested for PUCCH by PRACH repetition. If there is RACH repetition, the gNB will configure PUCCH repetition to UE.

In another example, the UE may indicate that repetition is requested for PUCCH by a repetition request for Msg 3. If there is an Msg 3 repetition request from the UE, the gNB will configure PUCCH repetition to UE.

In yet another example, the UE may indicate that repetition is requested for PUCCH by a specific PRACH resource. For example, there will be at least two sets of RACH resources. If a specific RACH resource is selected from the first set of RACH resources by the UE for PRACH transmission, the gNB will configure PUCCH repetition to the UE; otherwise, the gNB will configure PUCCH repetition to the UE.

In yet another example, the UE may indicate that repetition is requested for PUCCH by at least one bit in Msg A or in Msg 3 (or additional fields in Msg A or Msg 3). The UE may also indicate a repetition number by bits, e.g., 2 bits in Msg A or in Msg 3.

In yet another example, the UE may indicate to the gNB the preferred repetition number by a specific PRACH resource. For example, there may be multiple sets of RACH resources and each set of RACH resource is corresponding to a PUCCH repetition number, e.g. 1, 2, 4 or 8. By selecting a PRACH resource in a set, the preferred PUCCH repetition number at the UE side will be indicated to the gNB.

Besides the methods, embodiments of the present application also propose an apparatus of supporting PUCCH repetition.

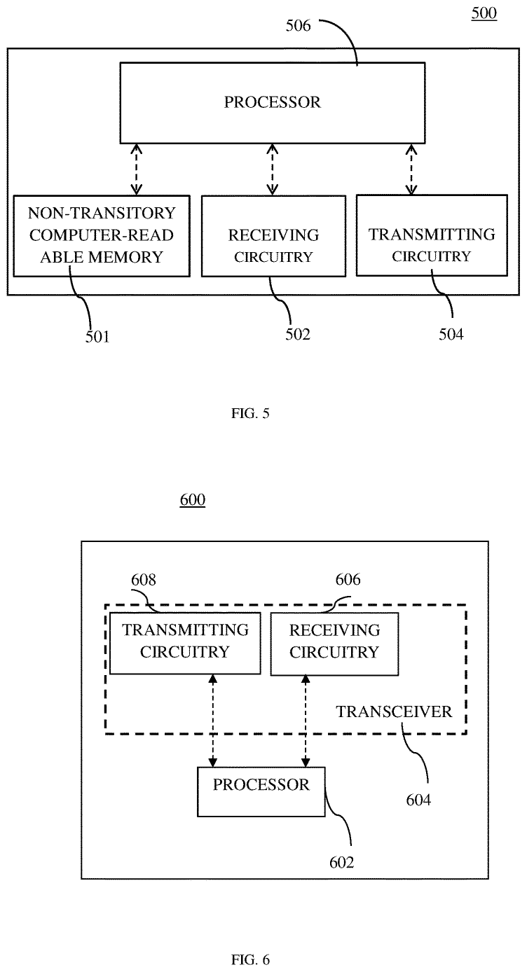

For example, FIG. 5 illustrates a block diagram of an apparatus of supporting PUCCH repetition 500 according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The at least one processor 506 may be a CPU, a DSP, a microprocessor etc. The apparatus 500 may be a gNB or the like, or a UE or the like, which are configured to perform a method illustrated in the above or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

In some embodiments of the present application, the non-transitory computer-readable medium 501 may have stored thereon computer-executable instructions to cause a processor to implement the method with respect to the gNB or the like as described above. For example, the computer-executable instructions, when executed, cause the processor 506 interacting with receiving circuitry 502 and transmitting circuitry 504, so as to perform the steps with respect to a gNB or the like as depicted above.

In some other embodiments of the present application, the non-transitory computer-readable medium 501 may have stored thereon computer-executable instructions to cause a processor to implement the method with respect to the UE or the like as described above. For example, the computer-executable instructions, when executed, cause the processor 506 interacting with receiving circuitry 502 and transmitting circuitry 504, so as to perform the steps with respect to a UE or the like as illustrated above.

FIG. 6 is a block diagram of an apparatus of supporting PUCCH repetition 600 according to some other embodiments of the present application.

Referring to FIG. 6, the apparatus 600, for example a gNB or a UE may include at least one processor 602 and at least one transceiver 604 coupled to the at least one processor 602. The transceiver 604 may include at least one separate receiving circuitry 606 and transmitting circuitry 604, or at least one integrated receiving circuitry 606 and transmitting circuitry 604. The at least one processor 602 may be a CPU, a DSP, a microprocessor etc.

According to some embodiments of the present application, when the apparatus 600 is a UE or the like, the processor is configured to: receive a first signaling indicating a first repetition number for a PUCCH resource; determine a second repetition number equal to or smaller than the first repetition number based on the first repetition number; determine time-frequency domain resources for each repetition of the PUCCH resource; and transmit the PUCCH resource with the second repetition number based on the determined time-frequency domain resources.

According to some other embodiments of the present application, when the apparatus 600 is a gNB or the like, the apparatus 600 is configured to: transmit a first signaling indicating a first repetition number for a PUCCH resource; determine a second repetition number equal to or smaller than the first repetition number based on the first signaling; determine time-frequency domain resources for each repetition of the PUCCH resource; and receive the PUCCH resource with the second repetition number based on the determined time-frequency domain resources.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
receive a first signaling indicating a first repetition number for a physical uplink control channel (PUCCH) resource;
determine a second repetition number equal to or smaller than the first repetition number based on the first repetition number;
determine time-frequency domain resources for each repetition of the PUCCH resource; and
transmit the PUCCH resource with the second repetition number based on the determined time-frequency domain resources.

2. The UE of claim 1, wherein the first signaling indicating the first repetition number is system information or downlink control information.

3. The UE of claim 1, wherein the first repetition number is indicated by hybrid automatic repeat request (HARQ) timing indicator.

4. The UE of claim 1, wherein a start position of the time-frequency domain resources for the PUCCH resource with the second repetition number is indicated by a second signaling, or is selected by remote side.

5. The UE of claim 1, wherein the first repetition number is determined based on a received row index associated with a repetition number for PUCCH in a configured or predefined table.

6. The UE of claim 1, wherein the first repetition number is determined based on a repetition number for Msg A, Msg 3 or physical random access channel (PRACH).

7. The UE of claim 1, wherein the at least one processor is configured to cause the UE to:
transmit information indicating repetition is requested for PUCCH or information indicating a repetition number for PUCCH before determining the first repetition number.

8. The UE of claim 7, wherein the information indicating repetition is requested for PUCCH is one of the following:
physical random access channel (PRACH) repetition;
a repetition request for Msg A or Msg 3;
at least one bit in Msg A or in Msg 3; or
a specific PRACH resource.

9. The UE of claim 1, wherein the second repetition number is determined based on at least one of the following:
reference signal received power (RSRP);
satellite position;
satellite elevation angle;
timing advanced value; or
distance between satellite and remote side.

10. The UE of claim 9, wherein the at least one processor is configured to cause the UE to: receive information indicating at least one threshold associated with the second repetition number:
RSRP threshold;
satellite position threshold;
satellite elevation angle threshold;
timing advanced value threshold; or
distance threshold between satellite and remote side.

11. The UE of claim 1, wherein the time-frequency domain resources for each repetition of the PUCCH resource are slot level or symbol level.

12. The UE of claim 11, wherein, in response to the time-frequency domain resources for each repetition being symbol level, a symbol level gap between adjacent repetitions will be configured or predefined.

13. The UE of claim 11, wherein, whether the time-frequency domain resources for each repetition of the PUCCH resource are slot level or symbol level is configured or is determined by one of the following:
a number of symbols for each repetition;
hybrid automatic repeat request (HARQ) timing indicator; or
HARQ resource indicator.

14. A base station, comprising:
at least one memory; and
at least one processor coupled with the at least one memory and configured to cause the base station to:
transmit a first signaling indicating a first repetition number for a physical uplink control channel (PUCCH) resource;
determine a second repetition number equal to or smaller than the first repetition number based on the first signaling;
determine time-frequency domain resources for each repetition of the PUCCH resource; and
receive the PUCCH resource with the second repetition number based on the determined time-frequency domain resources.

15. A method performed by a user equipment (UE), the method comprising:
receiving a first signaling indicating a first repetition number for a physical uplink control channel (PUCCH) resource;
determining a second repetition number equal to or smaller than the first repetition number based on the first repetition number;
determining time-frequency domain resources for each repetition of the PUCCH resource; and
transmitting the PUCCH resource with the second repetition number based on the determined time-frequency domain resources.

16. A processor for wireless communication, comprising:
at least one controller coupled with at least one memory and configured to cause the processor to:
receive a first signaling indicating a first repetition number for a physical uplink control channel (PUCCH) resource;
determine a second repetition number equal to or smaller than the first repetition number based on the first repetition number;
determine time-frequency domain resources for each repetition of the PUCCH resource; and
transmit the PUCCH resource with the second repetition number based on the determined time-frequency domain resources.

17. The processor of claim 16, wherein the first signaling indicating the first repetition number is system information or downlink control information.

18. The processor of claim 16, wherein the first repetition number is indicated by hybrid automatic repeat request (HARQ) timing indicator.

19. The processor of claim 16, wherein a start position of the time-frequency domain resources for the PUCCH resource with the second repetition number is indicated by a second signaling, or is selected by remote side.

20. The processor of claim 16, wherein the first repetition number is determined based on a received row index associated with a repetition number for PUCCH in a configured or predefined table.
